(19) United States
(12) Patent Application Publication
(10) Pub. No.: US 2009/0032988 A1
(43) Pub. Date: Feb. 5, 2009

(54) OPHTHALMIC LENS PROCESSING TO DECREASE DYNAMIC CONTACT ANGLE

(76) Inventors: Diana ZANINI, Jacksonville, FL (US); Stephen C. Pegram, Fruit Cove, FL (US); Scott L. Joslin, Ponte Vedra Beach, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/176,852

(22) Filed: Jul. 21, 2008

Related U.S. Application Data
(60) Provisional application No. 60/953,072, filed on Jul. 31, 2007.

(51) Int. Cl. B29D 11/00

(52) U.S. Cl. 264/2.6; 15/104.001

(57) ABSTRACT

This invention discloses methods and apparatus for processing s silicon ophthalmic lens. The processing includes exposing the ophthalmic lens to a solution of Tri(Propylene Glycol) Methyl Ether and decreasing the dynamic contact angle of the lens surface.

### RELATED APPLICATION

This application claims priority to the provisional application Ser. No. 60/953,072 filed Jul. 31, 2007.

### FIELD OF USE

This invention describes ophthalmic lenses formed with mold parts and expansion of the lenses utilizing a solution comprising Tri(Propylene Glycol) Methyl Ether.

### BACKGROUND

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. To prepare a lens using such mold parts, an uncured hydrogel lens formulation is placed between a front curve mold part and a back curve mold part. The mold parts are brought together to shape the lens formulation according to desired lens parameters. The lens formulation was subsequently cured, for example by exposure to heat and light, thereby forming a lens.

Following cure, the mold parts are separated and the lens remains adhered to one of the mold parts. In order to release a formed lens from a mold part to which the lens is adhered the lens can be swelled. The swelling facilitates release of the lens from the mold part.

The need for timely and consistent release of silicone hydrogel ophthalmic lenses has been addressed with the use of flammable organic solvents. Processes have been described in which a lens is immersed in an alcohol (ROH), amide (RCONR′R″) or N-alkyl pyrrolidone for 20-40 hours and in the absence of water, or in an admixture with water as a minor component. (see e.g., U.S. Pat. No. 5,258,490). However, although some success has been realized with the known processes, the use of highly concentrated organic solutions can present safety hazards; increased risk of down time to manufacturing line; highly cost of solution; and collateral damage, due to explosion.

Alternative methods for removing a silicone hydrogel lens from a FC mold surface during hydration involve the use of a solvent such as isopropyl alcohol (IPA). In this method 30% to 70% IPA is applied directly to the lens as it adheres to the mold surface. The solvent swells the lens and helps reduce the force holding the lens to the FC mold surface. The lens may then be removed from the mold surface. Although this method of lens release reduces the likelihood of damage to the lens, the use of a flammable liquid is not always desired.

It may also be beneficial to have a process which allows for demold and release of a lens in an aqueous solution. Unfortunately, many aqueous processed silicone hydrogels do not exhibit sufficiently high lens wettability as measured by dynamic contact angle (DCA).

Therefore it is desirable to have additional methods and apparatus conducive to imparting good wettability characteristics to the lens, and preferably not involve flammable solutions.

### SUMMARY

Accordingly, the present invention includes processes useful in the release of an ophthalmic lens from a mold part in which the lens was formed. The lenses are expanded through exposure to Tri(Propylene Glycol) Methyl Ether (hereinafter “TPME”), wherein the exposure of the lens to TPME causes the lens to swell.

In some embodiments, method steps of the present invention include curing a lens siloxane forming mixture to form an ophthalmic lens in a cavity formed between a first and second mold part proximate to each other. The first and second mold parts are separated, wherein subsequent to separation, the ophthalmic lens remains adhered to a first mold part. The first mold part and lens adhered to the first mold part are exposed to a solution of TPME, wherein the lens is released from the adhesion to the first mold part.

Embodiments can also include methods of producing an ophthalmic lens by methods described herein. The lens can include, for example, a silicone hydrogel formulation.

### DESCRIPTION OF THE DRAWINGS

FIG. 1 illustrates a mold assembly according to some embodiments of the present invention.

FIG. 1A illustrates a mold part with a lens adhered thereto.

FIG. 1B illustrates a mold part and a released lens.

FIG. 2 illustrates a flow chart of exemplary steps that can be executed while implementing some embodiments of the present to release a lens from a mold part.

FIG. 3 illustrates a flow chart of exemplary steps that can be executed while implementing some embodiments of the present to release an ophthalmic lens from a mold part.

FIG. 4 illustrates apparatus for implementing some embodiments of the present invention.

### DETAILED DESCRIPTION OF THE INVENTION

The present invention includes molds and methods for making an ophthalmic lens. Novel processes and apparatus are provided for increasing wettability of a contact lens. Specifically, the present invention includes methods and apparatus for processing silicon hydrogel ophthalmic lenses with a solution comprising TPME to facilitate lens wettability. In some embodiments, the present invention provides methods and apparatus for processing silicon hydrogel ophthalmic lenses with a non-flammable solution which swells the ophthalmic lenses and provides a beneficial effect on dynamic contact angle.

Ophthalmic lenses formed from siloxane monomers and polymers are largely hydrophobic and tend to regularly adhere to one or both of the front curve and back curve mold part. Release of the ophthalmic lens from the mold part requires some process to overcome this adherence.

According to some embodiments of the present invention, a polymerized ophthalmic lens attaches to one part of a multi-part mold that is used in the manufacture of the ophthalmic lens. The lens is exposed to a TPME solution either via submersion of the lens into a solution that includes TPME; or via a flow of solution including TPME over the lens. The TPME solution has the effect of swelling the lens. According to the present invention the lens swell increases wettability of the lens.

### DEFINITIONS

As used herein “DCA” refers to dynamic contact angle.

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision. In some embodiments, the preferred lenses of the invention are soft contact lenses are made from silicone elastomers or hydrogels, which include but are not limited to silicone hydrogels, and fluorohydrogels.

As used herein, the term “lens forming mixture” or “Reaction Mixture” refers to a monomer or prepolymer material which can be cured, to form an ophthalmic lens. Various embodiments can include lens forming mixtures with one or more additives such as: UV blockers, tints, photoinitiators or catalysts, and other additives one might desire in an ophthalmic lenses such as, contact or intraocular lenses. Lens forming mixtures are more fully described below.

As used herein, the term “lens swelling material” refers to any material which has the effect of swelling the lens material. A lens swelling material may therefore include a non-flammable organic solvent, such as, for example TPME.

As used herein, the term “mold” refers to a rigid or semi-rigid object that may be used to form lenses from uncured formulations. Some preferred molds include two mold parts forming a front curve mold part and a back curve mold part.

As used herein, “released from a mold,” means that a lens is either completely separated from the mold, or is only loosely attached so that it can be removed with mild agitation or pushed off with a swab.

As used herein, the term “TPME” refers to Tri(Propylene Glycol) Methyl Ether.

### Lenses

An ophthalmic lens that resides in or on the eye can facilitate vision correction or may provide a cosmetic effect. In some embodiments, a preferred lens type can include a lens that is made from silicone elastomers or hydrogels, such as, for example, silicone hydrogels, fluorohydrogels, including those comprising silicone/hydrophilic macromers, silicone based monomers, initiators and additives.

### Molds

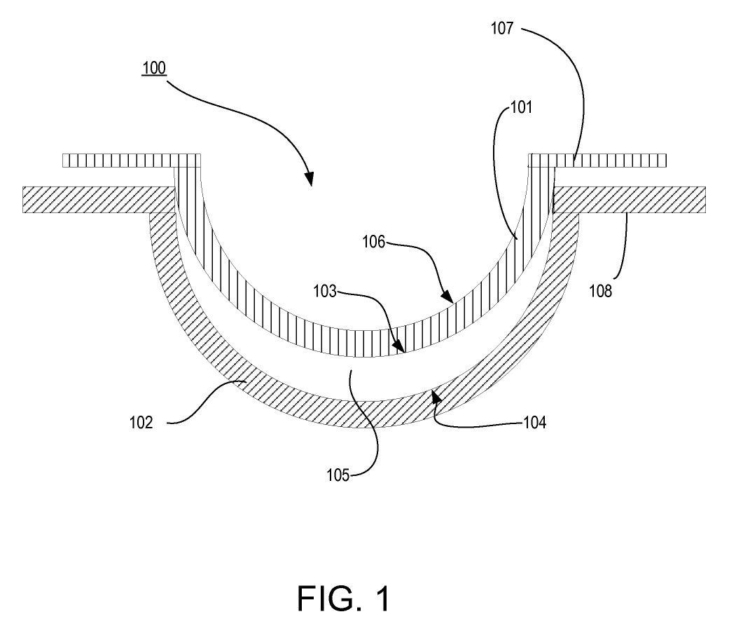

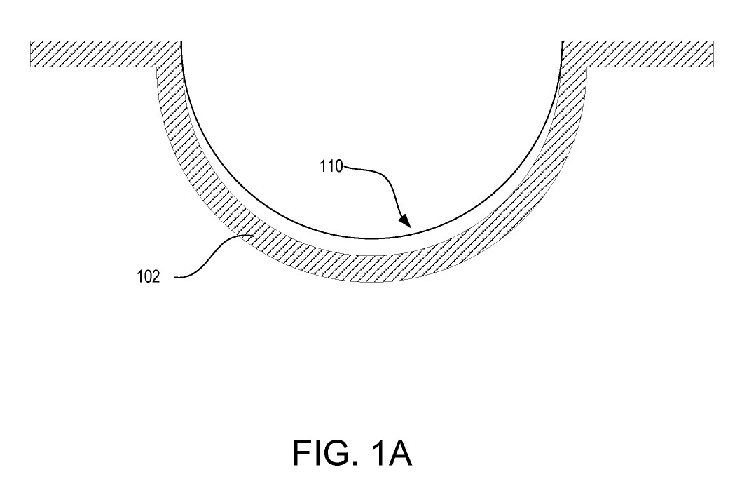

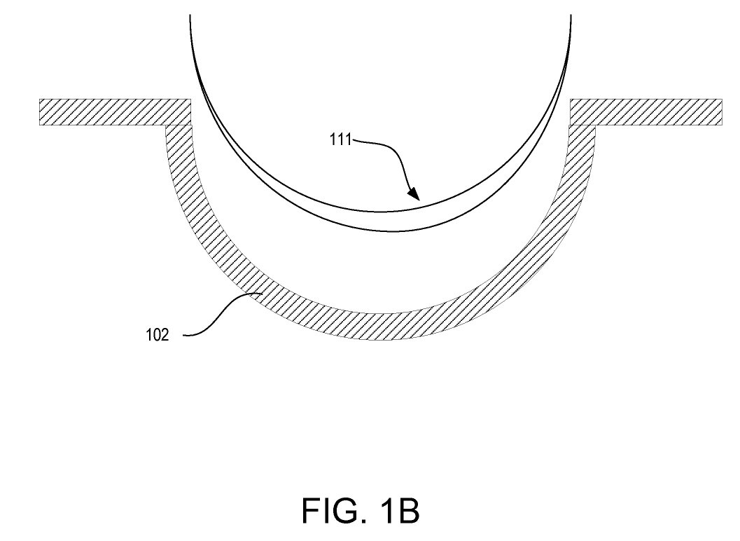

Referring now to FIG. 1, a diagram of an exemplary mold for an ophthalmic lens is illustrated. A mold assembly 100 has a cavity 105 into which a lens forming mixture can be dispensed such that upon reaction or cure of the lens forming mixture (not illustrated), an ophthalmic lens of a desired shape is produced. A mold assembly 100 which may be used in some preferred embodiments of this invention is made up of more than one “mold parts” or “mold pieces” 101-102. The mold parts 101-102 can be brought together such that a cavity 105 is formed there in a shape of the desired lens. This combination of mold parts 101-102 is preferably temporary. Upon formation of the lens, the mold parts 101-102 can again be separated for removal of the lens.

Thus, for example, in a preferred embodiment a mold assembly 100 is formed from two parts 101-102, a female concave piece (front piece) 102 and a male convex piece (back piece) 101 with a cavity formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

In some embodiments, the front mold piece 102 can also have an annular flange integral with, and surrounding, a circular circumferential edge 108 and extends from it in a plane normal to the axis and extending from the flange (not shown).

The back mold piece 101 has a central curved section with a concave surface 106, convex surface 103 and circular circumferential edge 107, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens, while the outer convex surface 103 of the base mold half 101 defines the inner surface of the ophthalmic lens.

Thermoplastics can include, for example, one or more of: polypropylene, polystyrene and alicyclic polymers and can additionally be compounded with one or more additives.

In some preferred methods of making molds 100 according to the present invention, injection molding is utilized according to known techniques, however, embodiments can also include molds fashioned by other techniques including, for example: lathing, diamond turning, or laser cutting.

Typically, lenses are formed on at least one surface of both mold parts 101-102. However, if need be one surface of the lenses may be formed from a mold part 101-102 and the other lens surface can be formed using a lathing method, or other methods.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof

FIG. 1A illustrates a mold part 102 is illustrated with an adhered lens 110 attached thereto. FIG. 1B illustrates a lens 111 released from the mold part 102.

### Methods

The following method steps are provided as examples of processes that may be implemented according to some aspects of the present invention. It should be understood that the order in which the method steps are presented are not meant to be limiting and other orders may be used to implement the invention. In addition, not all of the steps are required to implement the present invention and additional steps may be included in various embodiments of the present invention.

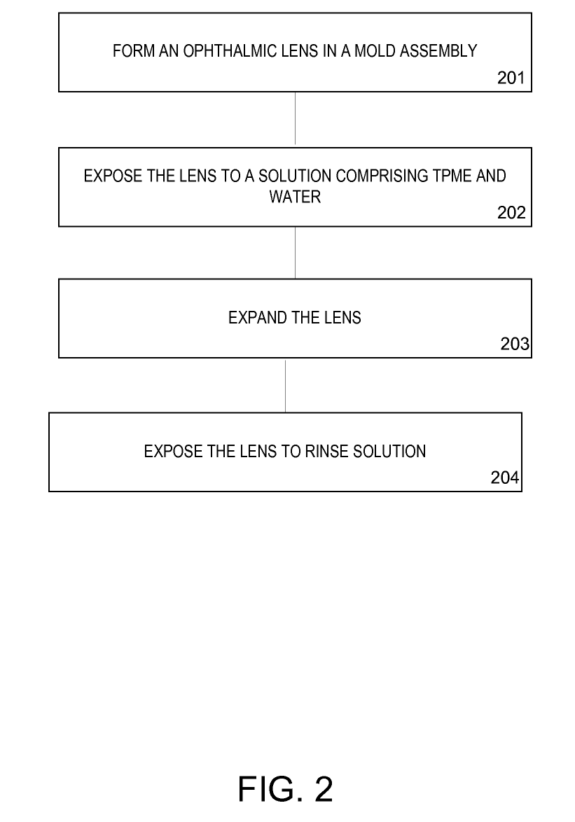

Referring now to FIG. 2, a flowchart illustrates exemplary steps that may be used to implement the present invention. At 201, an ophthalmic lens 110 is formed in a molding assembly as described above. At 202, a formed lens is exposed to a solution that includes TPME. The lens may be exposed to the TPME solution by submerging the lens in a TPME solution. As exemplified below in the examples, an effective amount of TPME may include any amount that increased wettability of the lens following the exposure of the lens to the TPME. In some preferred embodiments the TPME solution may include for example between about 10% and 100% TPME; in more preferred embodiments the solution may include between about 25% and 100% TPME; and some more preferred embodiments include about 75% to 100% TPME in solution. The solution may also include an aqueous solution. Additional embodiments may include an organic solution, such as isopropyl alcohol (hereinafter “IPA”).

Exposure to a TPME solution may be for any time period and concentration sufficient to swell the ophthalmic lens 110. In some preferred embodiments, exposure of the lens 110 to TPME solution is made for 20 minutes or more. Other embodiments include exposing the lens for a period of between 5 minutes and 40 minutes, with some preferred embodiments between 9 minutes and 35 minutes.

In addition, in some embodiments, a most preferred a time of exposure of the lens 110 to TPME solution can be dependent upon the temperature of the TPME solution. Generally, in some embodiments, an increase in temperature will decrease the amount of time of exposure of the lens 110 to TPME solution to bring about the same change in contact angle.

It is also noted that, according to the present invention, a particular concentration or range of concentration of TPME in a solution to which a lens is exposed may be most effective at swelling the ophthalmic lens 110 and increasing wettability. By way of non-limiting example, a most effective concentration includes a solution of greater than 95% TPME in aqueous solution.

At 203, the lens 110 will expand during the exposure to the TPME. Expansion may be generally uniform resulting in an increase in diameter of the lens 110 or may be irregular due to adhesion of some portion of the lens 110 to a mold part 101-102.

At 204, the lens may be exposed to a rinsing solution. Some preferred embodiments include a rinsing solution of deionized water (hereinafter “DI water”).

Exposure to the rinse solution can include, for example, submersion of the lens in DI water for 30 about minutes or exposure to a stream of water for about 30 minutes.

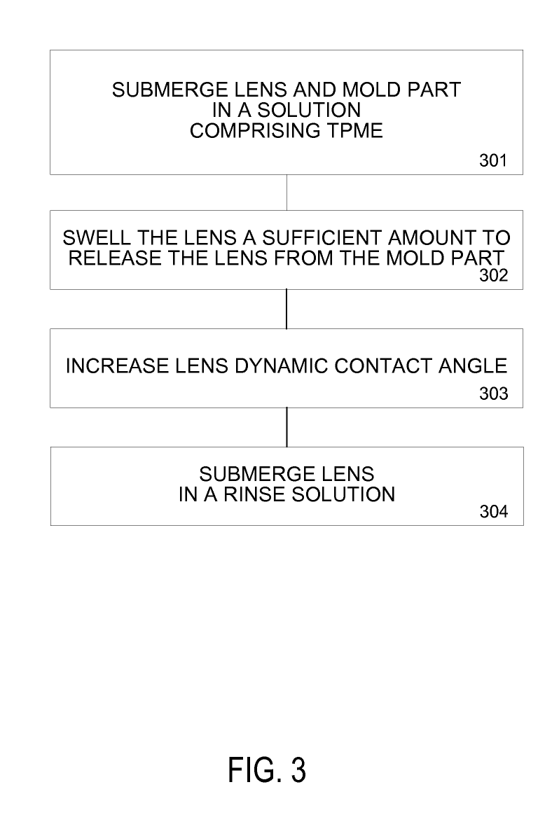

Referring now to FIG. 3, exemplary process steps for some embodiments are illustrated for increasing wettability of an ophthalmic lens 110.

By way of non-limiting example, wettability can be measured via determination of the dynamic contact angle or DCA, typically at 23° C., with borate buffered saline, using a Wilhelmy balance. The wetting force between the lens surface and borate buffered saline is measured using a Wilhelmy microbalance while the sample strip cut from the center portion of the lens is being immersed into or pulled out of the saline at a rate of 100 microns/sec. The following equation is used

F=γp cos θ or θ=cos⁻¹(F/γp)

where F is the wetting force, γ is the surface tension of the probe liquid, p is the perimeter of the sample at the meniscus and θ is the contact angle. Typically, two contact angles are obtained from a dynamic wetting experiment—advancing contact angle and receding contact angle. Advancing contact angle is obtained from the portion of the wetting experiment where the sample is being immersed into the probe liquid, and these are the values reported herein. Five lenses of each composition are measured and the average is reported.

At 301, an adhered lens 110 and mold part 101-102 can be submerged in, or otherwise exposed to a solution including TPME, and in some preferred embodiments an aqueous solution of greater than 95% TPME.

As discussed above, an alternative to submersion of a mold part 101-102 and adhered lens 110 in a TPME solution is to expose the mold part 101-102 and lens to a flow of TPME solution.

At 302, the lens 110 is swelled a sufficient amount to release the lens from the mold part 101-102.

At 303, wettability characteristics of the lens 110 are increased. The wettability can be determined according to a decrease in the DCA. Contact Angle analysis is used to measure the forces that affect the interaction of solids and liquids and can provide valuable information about surface properties.

Referring now again to FIG. 3, at 304 an optional additional step can include additionally submerging the released lens 111 in an aqueous solution of moderate temperature or between about 35° C. and 55° C. Submersion in the moderate temperature solution can be useful to stabilize the lens and to extract unreacted component or other unwanted materials from the released lens 111.

### Apparatus

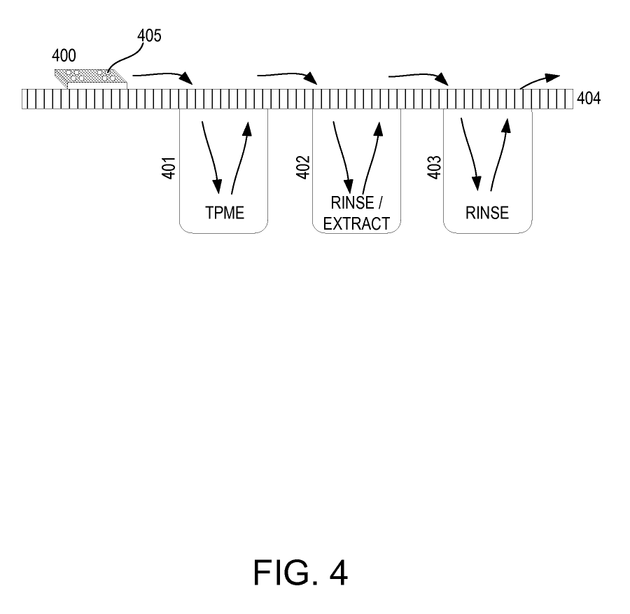

Referring now to FIG. 4, an apparatus is illustrated for implementing some embodiments of the present invention. The apparatus can include, for example, a conveyor 404, track or other locomotion apparatus to convey a carrier 400, such as a pallet, containing lenses 405. The conveyor 404 can transport the carrier 400 to the two or more hydration chambers.

A first hydration chamber 410 contains a first hydration solution which includes a TPME solution. In some embodiments, the first hydration solution may be heated or chilled to a desired temperature for example via commercial chillers to below 5° C. A second hydration chamber 402 can contain a second hydration solution, including, for example, DI water. In some embodiments, the second hydration may be heated.

In some embodiments, a third hydration chamber can be included and contain a third hydration solution. Typically, the third hydration solution will be a rinse solution.

It should be understood, that although one chamber has been illustrated for each of various thermal energy environments, two or more chambers can be used for each thermal energy environment. Use of multiple chambers can provide advantages such as, for example, greater flexibility in hydration solution volume 401-403.

### EXAMPLES

The following examples are included by way of non-limiting enablement for some embodiments of the present invention. Other embodiments are within the scope of the claims included below.

### Example 1

A reaction mixture (Table 1) was degassed on high vacuum (20(±2) mmHg, 25(±3)° C., 127(±3) rpm) for 15(±3) minutes. A reaction mixture was dosed into thermoplastic contact lenses molds, weights were placed on the molds for 20 seconds and then the molds were cured at 80° C., under a nitrogen atmosphere, with an irradiation of 1.5→7.0 mW/cm² (Philips High Intensity Bulbs: M2-B1-10) for a period of 12 minutes. The resulting lenses were hand demolded and released by submerging lenses in the front curve (FC) molds in DI water at 90(±10)° C. for about 5 minutes. Lenses were than transferred to jars and underwent two “change-out” steps—Step 1) DI water at 90(±5)° C. for a minimum of 30 minutes and Step 2) DI water at 25(±5)° C. for a minimum of 30 minutes. Lenses were then equilibrated in packing solution and inspected in packing solution. Lenses were packaged in vials containing 5 to 7 milliliter borate buffered saline solution, capped and sterilized at 120° C. for 30 minutes. Lens Diameter and dynamic contact angle (DCA) results are listed in Table 2.

The DCA can be measured, for example, according to the process described above.

TABLE 1
Reactive Monomer Mix Components for Examples 1-12

| | wt. % |
|---|---|
| Monomers | |
| Hydroxy-mPDMS | 55 |
| TEGDMA | 2 |
| DMA | 19.53 |
| HEMA | 9.00 |
| PVP K-90 | 12 |
| CGI 819 | 0.25 |
| Norbloc | 2.2 |
| Blue HEMA | 0.02 |
| Diluent | |
| TPME | 100 |
| monomer/diluent ratio | 60:40 |

TABLE 2
DCA and Lens Diameter Results for Examples 1-8

| Example | Lens Diameter (mm) | DCA |
|---|---|---|
| 1 | 14.85 | 87(14) |
| 2 | N/A | 66(6) |
| 3 | N/A | 67(5) |
| 4 | 18.40 | N/A |
| 5 and 9 | 15.55 | 81(9) |
| 6 and 10 | 15.45 | 81(15) |
| 7 and 11 | 15.05 | 98(4) |
| 8 and 12 | 22.45 | 62(4) |

### Example 2

Contact lenses were made exactly as per Example 1. After sterilization, lenses were removed from packages and underwent the following conditions: 1) treatment with 70/30 IPA/DI water for 30 minutes; 2) a second treatment with 70/30 IPA/DI water for 30 minutes; 3) a third treatment with 70/30 IPA/DI water for 30 minutes; 4) treatment with 100% DI Water for 30 minutes; and 5) a second treatment with 100% DI Water for 30 minutes. Lenses were then equilibrated in packing solution and inspected in packing solution. Lenses were packaged in vials containing 5 to 7 milliliter borate buffered saline solution, capped and sterilized at 120° C. for 30 minutes. Dynamic contact angle (DCA) results are listed in Table 2.

### Example 3

Contact lenses were made exactly as per Example 1. After sterilization, lenses were removed from packages and underwent the following conditions: 1) treatment with 100% TPME solution for 60 minutes; 2) treatment with 100% DI Water for 30 minutes; and 3) a second treatment with 100% DI Water for 30 minutes. Lenses were then equilibrated in packing solution and inspected in packing solution. Lenses were packaged in vials containing 5 to 7 ml borate buffered saline solution, capped and sterilized at 120° C. for 30 minutes. Dynamic contact angle (DCA) results are listed in Table 2.

### Example 4

Contact lenses were made exactly as per Example 1. After sterilization, lenses were removed from packages and placed into 70/30 IPA/DI Water (1 lens/10 mls) solution. Lenses were allowed to equilibrate in the solution overnight. Lenses were measured for diameter. Diameter is listed in Table 2.

### Example 5

Contact lenses were made exactly as per Example 1. After sterilization, lenses were removed from packages and placed into 25/75 TPME/DI Water (1 lens/10 mls) solution. Lenses were allowed to equilibrate in the solution overnight. Lenses were measured for diameter. Diameter is listed in Table 2.

### Example 6

Contact lenses were made exactly as per Example 1. After sterilization, lenses were removed from packages and placed into 50/50 TPME/DI Water (1 lens/10 mls) solution. Lenses were allowed to equilibrate in the solution overnight. Lenses were measured for diameter. Diameter is listed in Table 2.

### Example 7

Contact lenses were made exactly as per Example 1. After sterilization, lenses were removed from packages and placed into 75/25 TPME/DI Water (1 lens/10 mls) solution. Lenses were allowed to equilibrate in the solution overnight. Lenses were measured for diameter. Diameter is listed in Table 2.

### Example 8

Contact lenses were made exactly as per Example 1. After sterilization, lenses were removed from packages and placed into 100% TPME (1 lens/10 mls) solution.

Lenses were allowed to equilibrate in the solution overnight. Lenses were measured for diameter. Diameter is listed in Table 2.

### Example 9

Contact lenses were made exactly as per Example 1. After sterilization, lenses were removed from packages and underwent the following conditions: 1) treatment with 25/75 TPME/DI Water for 60 minutes; 2) treatment with 100% DI Water for 30 minutes; and 3) a second treatment with 100% DI Water for 30 minutes. Lenses were then equilibrated in packing solution and inspected in packing solution. Lenses were packaged in vials containing 5 to 7 ml borate buffered saline solution, capped and sterilized at 120° C. for 30 minutes. Dynamic contact angle (DCA) results are listed in Table 2.

### Example 10

Contact lenses were made exactly as per Example 1. After sterilization, lenses were removed from packages and underwent the following conditions: 1) treatment with 50/50 TPME/DI Water for 60 minutes; 2) treatment with 100% DI Water for 30 minutes; and 3) a second treatment with 100% DI Water for 30 minutes. Lenses were then equilibrated in packing solution and inspected in packing solution. Lenses were packaged in vials containing 5 to 7 ml borate buffered saline solution, capped and sterilized at 120° C. for 30 minutes. DCA results are listed in Table 2.

### Example 11

Contact lenses were made exactly as per Example 1. After sterilization, lenses were removed from packages and underwent the following conditions: 1) treatment with 75/25 TPME/DI Water for 60 minutes; 2) treatment with 100% DI Water for 30 minutes; and 3) a second treatment with 100% DI Water for 30 minutes. Lenses were then equilibrated in packing solution and inspected in packing solution. Lenses were packaged in vials containing 5 to 7 ml borate buffered saline solution, capped and sterilized at 120° C. for 30 minutes. DCA results are listed in Table 2.

### Example 12

Contact lenses were made exactly as per Example 1. After sterilization, lenses were removed from packages and underwent the following conditions: 1) treatment with 100% TPME for 60 minutes; 2) treatment with 100% DI Water for 30 minutes; and 3) a second treatment with 100% DI Water for 30 minutes. Lenses were then equilibrated in packing solution and inspected in packing solution. Lenses were packaged in vials containing 5 to 7 ml borate buffered saline solution, capped and sterilized at 120° C. for 30 minutes. DCA results are listed in Table 2.

### CONCLUSION

The present invention, as described above and as further defined by the claims below, provides methods of processing ophthalmic lenses and apparatus for implementing such methods, as well as ophthalmic lenses formed thereby.

What is claimed:

1. A method of processing an ophthalmic lens, the method comprising;
forming an ophthalmic lens from a lens forming mixture comprising a siloxane;
exposing the ophthalmic lens to a solution comprising Tri(Propylene Glycol) Methyl Ether to swell the ophthalmic lens; and
exposing the lens to a rinse solution.

2. The method of claim 1, wherein the exposure of the ophthalmic lens to a solution comprising Tri(Propylene Glycol) Methyl Ether solution is sufficient to decrease the dynamic contact angle of a surface of the lens.

3. The method of claim 2, wherein prior to the step of exposing the ophthalmic lens to a solution comprising Tri(Propylene Glycol) Methyl Ether the dynamic contact angle of the surface of the lens is about 90° or more.

4. The method of claim 2, wherein subsequent to the step of exposing the ophthalmic lens to a solution comprising Tri(Propylene Glycol) Methyl Ether the dynamic contact angle is about 85° or less.

5. The method of claim 3, wherein subsequent to the step of exposing the ophthalmic lens to a solution comprising Tri(Propylene Glycol) Methyl Ether the dynamic contact angle is about 90° or less.

6. The method of claim 1, wherein the step of exposing the ophthalmic lens to a solution comprising Tri(Propylene Glycol) Methyl Ether comprises submerging the lens in the solution.

7. The method of claim 6 wherein the ophthalmic lens comprises a first surface and a second surface and at least one surface is covered with the submerged solution comprising Tri(Propylene Glycol) Methyl Ether.

8. The method of claim 1 wherein the rinse solution comprises deionized water.

9. The method of claim 6 wherein the step of exposing the ophthalmic lens to a rinse solution comprises submerging said lens in the rinse solution.

10. The method of claim 6 wherein the step of exposing the ophthalmic lens to a rinse solution comprises exposing said lens to a stream of solution.

11. The method of claim 6 wherein the solution comprising Tri(Propylene Glycol) Methyl Ether solution comprises 90% or more Tri(Propylene Glycol) Methyl Ether.

12. The method of claim 6 wherein the solution comprises about 95% or more Tri(Propylene Glycol) Methyl Ether.

13. The method of claim 6 wherein the solution comprises 100% Tri(Propylene Glycol) Methyl Ether.

14. The method of claim 6 wherein the lens is exposed to the solution comprising Tri(Propylene Glycol) Methyl Ether solution for a period of 6 minutes or more.

15. The method of claim 6 wherein the lens is exposed to the solution comprising Tri(Propylene Glycol) Methyl Ether solution for a period of 10 minutes or more.

16. Apparatus for processing an ophthalmic lens comprising silicone, the apparatus comprising:
a carrier for transporting one or more ophthalmic lenses, each lens wherein the carrier allows the ophthalmic lens to be exposed to hydration solution proximate to the carrier;
a first hydration chamber comprising a first solution comprising Tri(Propylene Glycol) Methyl Ether;
a second hydration chamber comprising a second solution comprising a rinse solution; and
a transport for conveying one or more ophthalmic lenses from the first hydration chamber to the second hydration chamber.

17. The apparatus of claim 16 wherein the a first hydration chamber is of sufficient volume to expose the lens to 10 milliliters or more of first solution comprising Tri(Propylene Glycol) Methyl Ether.

18. The apparatus of claim 17 wherein the first hydration solution comprises between about 95% and 100% Tri(Propylene Glycol) Methyl Ether.

19. An ophthalmic lens produced by a method comprising the steps of:
curing a lens forming mixture comprising a siloxane to form an ophthalmic lens in a cavity formed between a first and second mold part proximate to each other;
separating the two or more mold parts;
releasing the lens from one or both of the first mold part and the second mold part;
exposing the ophthalmic lens to a solution comprising Tri(Propylene Glycol) Methyl Ether; and
exposing the lens to a rinse solution.

20. The lens of claim 19 wherein the step of exposing the ophthalmic lens to a solution comprising Tri(Propylene Glycol) Methyl Ether; comprises solution of at least 90% Tri(Propylene Glycol) Methyl Ether.

21. A method of processing an ophthalmic lens, the method comprising;
forming an ophthalmic lens from a lens forming mixture comprising a siloxane;
exposing the ophthalmic lens to a non-flammable solution capable of swelling the ophthalmic lens; and
exposing the lens to a rinse solution.

22. An ophthalmic lens produced by a method comprising the steps of:
curing a lens forming mixture comprising a siloxane to form an ophthalmic lens in a cavity formed between a first and second mold part proximate to each other;
separating the two or more mold parts;
releasing the lens from one or both of the first mold part and the second mold part;
exposing the ophthalmic lens to a non-flammable solution capable of swelling the ophthalmic lens; and
exposing the lens to a rinse solution.
